(19) United States
(12) Patent Application Publication
(10) Pub. No.: US 2014/0207838 A1
(43) Pub. Date: Jul. 24, 2014

(54) METHOD, APPARATUS AND SYSTEM FOR EXECUTION OF A VECTOR CALCULATION INSTRUCTION

(71) Applicants: Klaus Danne, Braunschweig (DE); Tian Yang, Berlin (DE); Frank Richter-Trautmann, Braunschweig (DE)

(72) Inventors: Klaus Danne, Braunschweig (DE); Tian Yang, Berlin (DE); Frank Richter-Trautmann, Braunschweig (DE)

(21) Appl. No.: 13/994,034

(22) PCT Filed: Dec. 22, 2011
(86) PCT No.: PCT/US11/67005

§ 371 Date: Jun. 13, 2013

(51) Int. Cl. G06F 17/16

(52) U.S. Cl. CPC G06F 17/16
USPC 708/235

(57) ABSTRACT

Techniques and mechanisms for executing a vector instruction with a processor. In an embodiment, a vector definition instruction is executed to perform operations associated with setting a first vector as a reference vector, the operations resulting in vector multiplication information being stored in a look-up table. In another embodiment, a vector multiplication instruction is subsequently executed to perform a vector multiplication calculation based on the vector multiplication information stored in the look-up table.

### BACKGROUND OF THE INVENTION

1. Field of the Invention

Embodiments generally relate to techniques for performing a vector calculation in a processor of a computer system. More particularly, certain embodiments provide for execution of one vector instruction to make a preliminary vector calculation available for access by execution of a subsequent vector instruction.

2. Background Art

Improvements in integrated circuit (IC) fabrication have allowed for smaller and/or more densely integrated processor architectures. The circuitry in such processors is generally trending toward increasing sensitivity to inefficiencies in power use. Consequently, incremental improvements in power efficiency tend to result in increasingly important performance gains in such processors.

The need for such gains is increased by successive generations of larger, more complex computing environments (e.g. on-line gaming, streaming, cloud networking, virtualization and/or the like) which tend to require increasingly processor-intensive performance in computer platforms. Accordingly, further improvements in power use will be needed as successively smaller form factor platforms are asked to support successively larger processing loads.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating elements of a computer system for communicating a vector instruction according to an embodiment.

FIG. 2 is a block diagram illustrating elements of a processor for executing a vector instruction according to an embodiment.

FIG. 3 is a flow diagram illustrating elements of method for executing a vector instruction according to an embodiment.

FIG. 4 is a block diagram illustrating elements of a processor for executing a vector instruction according to an embodiment.

FIG. 5 is a timing diagram illustrating vector calculation operations performed according to an embodiment.

### DETAILED DESCRIPTION

Embodiments discussed herein variously provide techniques and/or mechanisms for improved energy efficiency in implementation of vector calculations—e.g. where one operand may remain unchanged across multiple vector calculations. Such techniques and/or mechanisms may, for example, be applied in graphics, digital-signal-processing and/or multimedia applications, although certain embodiments are not limited in this regard.

In an embodiment, a processor may support—e.g. as a machine instruction in an instruction set—a first type of vector instruction, referred to herein as a vector definition (“dot-vdef”) instruction, for the processor to set some operand vector as a current reference vector. Execution of a dot-vdef instruction may, for example, include the processor calculating a set of one or more dot-product values and loading such a set into a lookup table of the processor. Such lookup table information may be made available for later access—e.g. during execution of some other vector instruction by the processor. For example, the processor may support a second type of vector instruction, referred to herein as a vector multiplication (“dot-vmul”) instruction, for the processor to return a value equal to a dot-product of the current reference vector and some operand of the dot-vmul instruction.

By way of illustration, a “dot-vdef X” instruction may be executed to define that some vector X is to serve as a current reference vector. Execution of the “dot-vdef X” instruction may include one or more dot-products being pre-computed and loaded into a lookup table—e.g. each dot-product for vector X and a respective binary vector. A subsequent “dot-vmul Y” instruction may reference (e.g. implicitly reference) the current reference vector, where the “dot-vmul Y” instruction is decoded as an instruction to return a value equal to the dot-product X-Y. Execution of the “dot-vmul Y” instruction may include arithmetic logic of the processor computing X-Y—e.g. based on one or more of the pre-computed dot-products which were previously stored in the look-up-table by the most recent dot-vref instruction, “dot-vdef X”. Information in vector Y may determine which pre-computed dot-products are to contribute to the calculation of X-Y. For example, the vector Y may be used to address one or more entries of a look-up-table during execution of the “dot-vmul Y” instruction.

Use of such the dot-vdef instruction type and/or dot-vmul instruction type may, for example, apply directly to scalar multiplication or dot-product multiplication of fixed-point operands and/or indirectly to more complex operations that build up on such scalar or dot-product multiplication. The cost to processor resources (e.g. time, energy, hardware and/or the like) in determining and storing lookup table information for a reference vector may be amortized by repeated use of such information over multiple subsequent vector multiplication operations. Additionally or alternatively, a variable-sized look-up table, multiple look-up tables and/or multi-ported look-up table may be used to support dot-vdef and/or dot-vmul execution.

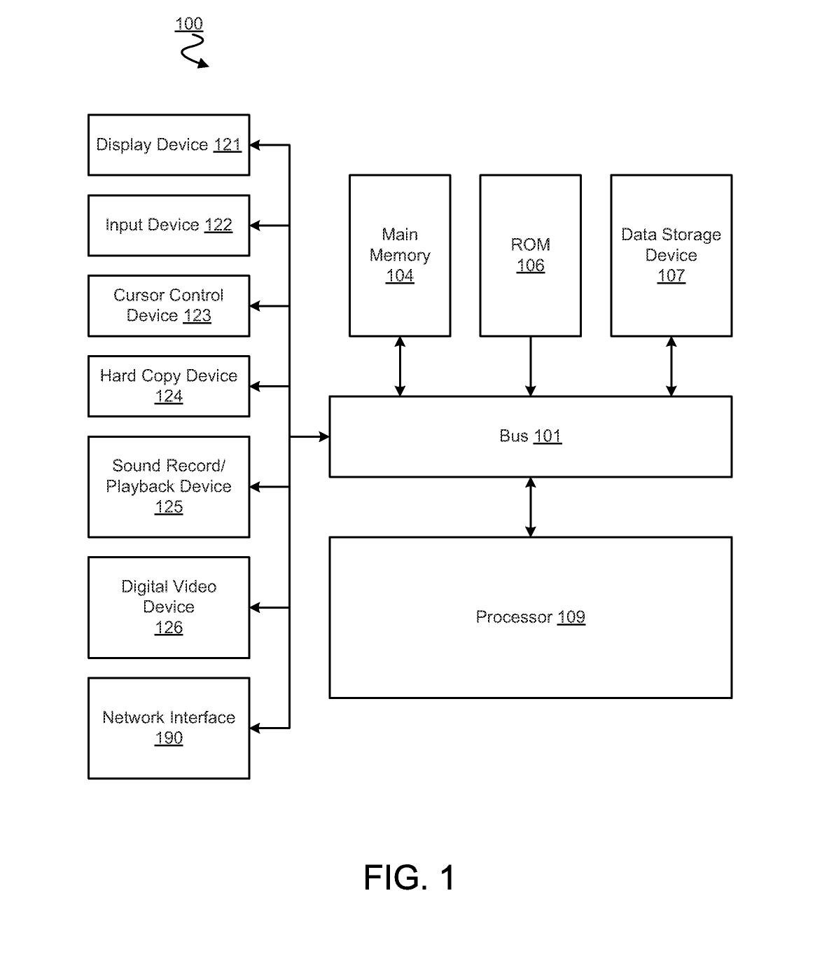

FIG. 1 shows elements of an illustrative computer platform 100 for performing a vector calculation according to one embodiment. Computer platform 100 may, for example, include a hardware platform of a personal computer such as a desktop computer, laptop computer, a handheld computer—e.g. a tablet, palmtop, cell phone, media player, and/or the like—and/or other such computer system. Alternatively or in addition, computer platform 100 may provide for operation as a server, workstation, or other such computer system. Alternatively, embodiments may be implemented in one or more embedded applications (e.g. in a data processing system of an automobile, mobile network base station, etc.) where, for example, an embedded processor is to implement digital signal processing or any of a variety of other applications involving extensive vector calculations.

In an embodiment, computer platform 100 includes at least one interconnect, represented by an illustrative bus 101, for communicating information and a processor 109—e.g. a central processing unit—for processing such information. Processor 109 may include functionality of a complex instruction set computer (CISC) type architecture, a reduced instruction set computer (RISC) type architecture and/or any of a variety of processor architecture types. Processor 109 may couple with one or more other components of computer platform 100 via bus 101. By way of illustration and not limitation, computer platform 100 may include a random access memory (RAM) or other dynamic storage device, represented by an illustrative main memory 104 coupled to bus 101, to store information and/or instructions to be executed by processor 109. Main memory 104 also may be used for storing temporary variables or other intermediate information during execution of instructions by processor 109. Computer platform 100 may additionally or alternatively include a read only memory (ROM) 106, and/or other static storage device—e.g. where ROM 106 is coupled to processor 109 via bus 101—to store static information and/or instructions for processor 109.

In an embodiment, computer platform 100 additionally or alternatively includes a data storage device 107 (e.g., a magnetic disk, optical disk, and/or other machine readable media) coupled to processor 109—e.g. via bus 101. Data storage device 107 may, for example, include instructions or other information to be operated on and/or otherwise accessed by processor 109. In an embodiment, processor 109 may perform vector calculations based on operand information stored in main memory 104, ROM 106, data storage device 107 or any other suitable data source.

Computer platform 100 may additionally or alternatively include a display device 121 for displaying information to a computer user. Display device 121 may, for example, include a frame buffer, a specialized graphics rendering device, a cathode ray tube (CRT), a flat panel display and/or the like. Additionally or alternatively, computer platform 100 may include an input device 122—e.g. including alphanumeric and/or other keys to receive user input. Additionally or alternatively, computer platform 100 may include a cursor control device 123, such as a mouse, a trackball, a pen, a touch screen, or cursor direction keys to communicate position, selection or other cursor information to processor 109, and/or to control cursor movement—e.g. on display device 121.

Computer platform 100 may additionally or alternatively have a hard copy device 124 such as a printer to print instructions, data, or other information on a medium such as paper, film, or similar types of media. Additionally or alternatively, computer platform 100 may include a sound record/playback device 125 such as a microphone or speaker to receive and/or output audio information. Computer platform 100 may additionally or alternatively include a digital video device 126 such as a still or motion camera to digitize an image.

In an embodiment, computer platform 100 includes or couples to a network interface 190 for connecting computer platform 100 to one or more networks (not shown)—e.g. including a dedicated storage area network (SAN), a local area network (LAN), a wide area network (WAN), a virtual LAN (VLAN), an Internet and/or the like. By way of illustration and not limitation, network interface 190 may include one or more of a network interface card (NIC), an antenna such as a dipole antenna, or a wireless transceiver, although the scope of the present invention is not limited in this respect.

Processor 109 may support instructions similar to those in any of a variety of conventional instruction sets—e.g. an instruction set which is compatible with the x86 instruction set used by existing processors. By way of illustration and not limitation, processor 109 may support operations corresponding to some or all operations supported in the IA™ Intel Architecture, as defined by Intel Corporation of Santa Clara, Calif. (see “IA-32 Intel® Architecture Software Developers Manual Volume 2: Instruction Set Reference,” Order Number 245471, available from Intel of Santa Clara, Calif. on the world wide web at developer.intel.com). As a result, processor 109 may support one or more operations corresponding, for example, to existing x86 operations, in addition to the operations of certain embodiments.

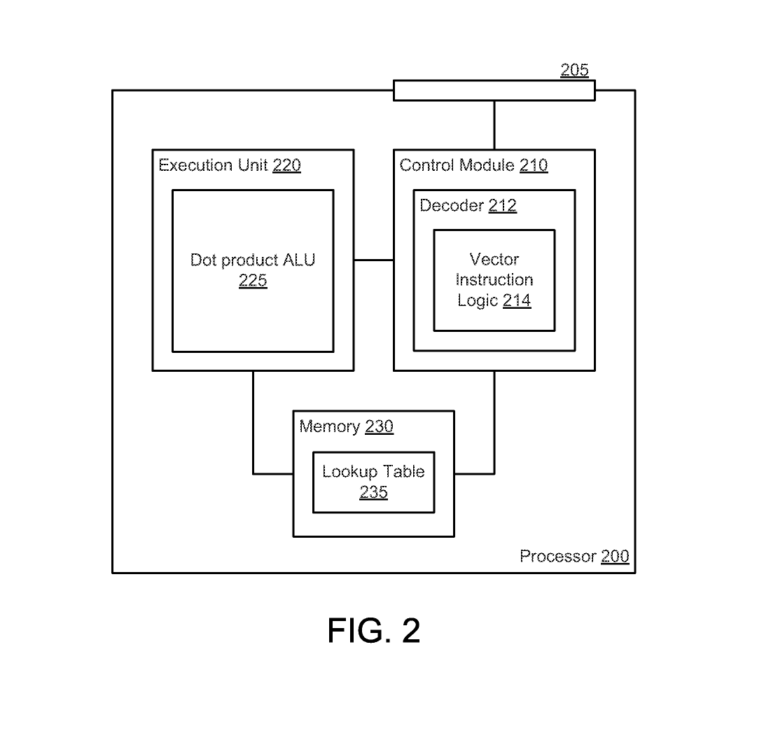

FIG. 2 illustrates select elements of a processor 200 for executing a vector instruction according to an embodiment. Processor 200 may be coupled to operate in a computer platform—e.g. a platform providing some or all of the functionality of computer platform 100. For example, processor 200 may include some or all of the features of processor 109, although certain embodiments are not limited in this regard. By way of illustration and not limitation, processor 200 may include a central processing unit (CPU), a math co-processor, a graphics processor and/or any of a variety of additional or alternative data-processing devices for executing machine instructions.

Processor 200 may include an interface 205 to receive information—e.g. data, address and/or command information—which processor 200 exchanges with another component of the computer platform. Interface 205 is shown in FIG. 2 as an interface to couple processor 200 to external hardware of a computer platform—e.g. via a bus or other communication hardware. However, in an alternate embodiment, interface 205 may be internal interface of an integrated circuit which couples the circuit logic of processor 200 to other on-chip circuit logic (e.g. uncore logic of a system-on-chip). In another embodiment, interface 205 may operate as an internal interface for multiple cores of processor 200 to communicate with one another.

Interface 205 may couple directly or indirectly to a control module 210 of processor 200. Control module 210 may include circuit logic to provide control signaling for directing operation of various components of processor 200. For example, control module 210 may provide control functionality for determining or otherwise controlling execution of one or more vector instructions. In an embodiment, control module 210 includes or otherwise has access to a decoder 212 of processor 200 which includes circuit logic to detect an instruction received via interface 205 and further to identify an instruction type associated with the detected instruction. Such an identified instruction type may, for example, be one a plurality of instruction types in an instruction set supported by processor 200. Based at least in part on the identified instruction type, decoder 212 may signal that one or more operations are to be performed, the operations for execution of the detected instruction. In an embodiment, decoder 212 includes logic to decode of any of a variety of one or more conventional machine code instructions.

Processor 200 may further include an execution unit 220 coupled directly or indirectly to control module 210, the execution unit 220 including circuit logic to perform one or more data operations for execution of an instruction. Execution unit 220 may, for example, include circuit logic to variously execute an operation based on decoder 212 decoding an instruction.

In an embodiment, decoder 212 includes or otherwise has access to vector instruction logic 214 including circuitry to decode instructions of one or more vector instruction types. As used herein, “vector instruction” refers to an instruction the execution of which includes performing one or more operations involving at least one vector—e.g. a vector having multiple elements. Execution unit 220 may execute one or more operations based on one or more control signals from control module 210—e.g. including a control signal exchanged in response to vector instruction logic 214 detecting that a received instruction is of a particular vector instruction type.

In an embodiment, vector instruction logic 214 includes logic to implement decoding of a dot-vdef instruction type. Execution of an instruction which is of a dot-vdef instruction type may set a vector as being a reference vector—e.g. where the reference vector is made available for use by any subsequent instructions of a vector instruction type. Such a subsequent vector instruction may, in an embodiment, be of an instruction type which is recognized by vector instruction logic 214 as implicitly referencing the current reference vector. In an embodiment where a dot-vdef instruction sets a particular vector as the reference vector, that particular vector may remain the current reference vector until execution of a subsequent dot-vdef instruction sets another vector to be the reference vector.

In an embodiment, vector instruction logic 214 includes logic to implement decoding of a dot-mul instruction type to specify or otherwise indicate an operand vector to be multiplied by the current reference vector. For example, execution of the dot-mul instruction may return a value equal to a dot-product of that operand vector and the current reference vector. A dot-mul instruction may include command information specifying a vector dot-product operation. The dot-mul instruction may additionally include data information specifying elements of the operand vector and/or address information specifying a location of the operand vector in memory of the computer platform. Any of a variety of additional or alternative techniques may be provided for a dot-vmul operation to indicate an operand vector

In an embodiment, execution unit 220 may include logic—represented by an illustrative dot product arithmetic logic unit (ALU) 225—to implement one or more operations for execution of the dot-vdef instruction type described above. Execution of a dot-vdef instruction may include dot product ALU 225 and/or similar logic of execution unit 220 calculating a plurality of values each corresponding to a different respective vector in a set of vectors. In an embodiment, the set of vectors includes one or more Boolean vectors. As used herein, “Boolean vector” refers to a vector in which each element within the vector has only a respective one of two possible Boolean values—e.g. one of logical ‘0’ and logical ‘1’. Determining one of the plurality of values may, for example, include execution unit 220 calculating a dot-product of the reference vector and the corresponding Boolean, or other, vector. In an embodiment, for each of the plurality of values, determining the value may include calculating a dot-product of the reference vector and the corresponding vector for that value.

Execution of a dot-vdef instruction may pre-compute and store a larger plurality of values than those given by dot-products of the reference-vector with respective Boolean vectors. For example, an embodiment may pre-compute and store a plurality of values given by dot-products of the reference vector with any of a variety of possible vectors with the same dimension and word width. For the sake of demonstrating features of various embodiments, execution of various vector instructions are discussed herein in terms of calculating a plurality of values which each corresponding to a respective Boolean vector. However, such discussion may be extended to apply to calculating values which correspond to any of a variety of additional or alternative types of vectors.

Processor 200 may include a memory 230 for storing the plurality of values—e.g. in a lookup table 235. Memory 230 may, for example, include a cache, a register file and/or any of a variety of additional or alternative storage means. Execution unit 220 may store the plurality of values in lookup table 235—e.g. as part of execution of a dot-vdef instruction. The plurality of values stored in lookup table 235 may be made available as reference information to be accessed for execution of one or more subsequent vector instructions—e.g. including a dot-vmul instruction. In an embodiment, the plurality of values may remain available in lookup table 235 as reference information even after being accessed by execution of a subsequent dot-vmul instruction.

In an embodiment, dot product arithmetic logic unit (ALU) 225 and/or other such arithmetic circuit logic in execution unit 220 may implement one or more operations for execution of a dot-vmul instruction. A dot-vmul instruction may implicitly (e.g. merely implicitly) reference the current reference vector. A dot-vmul instruction may include one or more parameters to specify or otherwise indicate an operand vector which is to be multiplied by the current reference vector. Execution of a dot-vmul may return a value equal to a dot-product of the current reference vector and an operand vector indicated by one or more parameters of the dot-vmul instruction. In an embodiment, execution unit 220 may include a plurality of ALUs, each to implement functionality similar to that of ALU 225. For example, multiple dot-vdef-capable ALUs of execution unit 220 may each support at the same time a different respective reference vector for various dot-vmul computations.

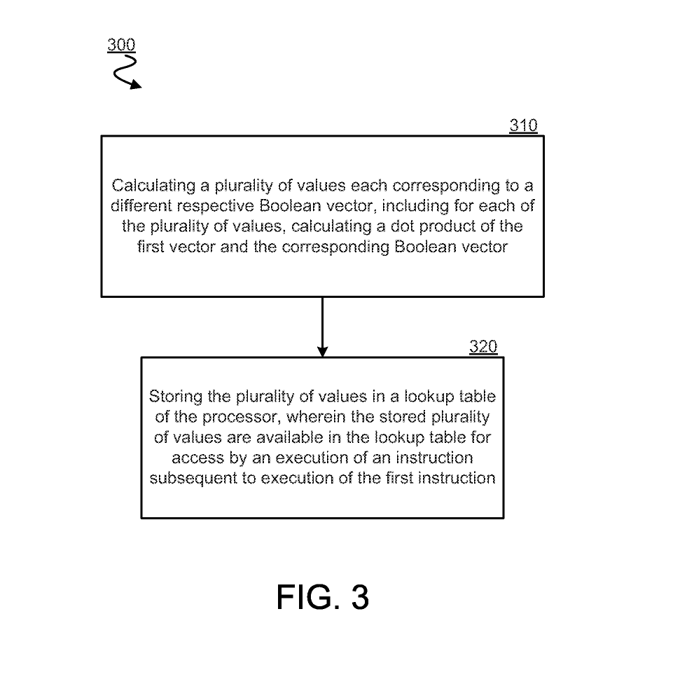

FIG. 3 illustrates some elements of a method 300 for executing a vector instruction according to an embodiment. Method 300 may be performed by a processor including some or all of the functionality of processor 200, although certain embodiments are not limited in this regard.

In an embodiment, method 300 is performed by a processor in the course of executing a first instruction of a vector definition instruction type. The processor may, for example, implement or otherwise include an instruction set which supports a plurality of instruction types including the vector definition instruction type. The first instruction may include data and/or address information providing an indication of a first vector—e.g. where execution of the first instruction is to perform operations associated with setting the first vector as a reference vector.

The execution of the first instruction in method 300 may include, at 310, calculating a plurality of values each corresponding to a different respective Boolean vector. In an embodiment, for each of the Boolean vectors, calculating the corresponding one of the plurality of values includes calculating a dot product of the first (reference) vector and that Boolean vector. In an embodiment, the vector definition instruction type supports implicit reference to the corresponding Boolean vectors which are to be used in calculating the plurality of values. For example, an instruction of the dot-vdef instruction type may forego an explicit identifier of any or all Boolean vectors which are each to be variously multiplied by the reference vector.

Method 300 may further include, at 320, storing the plurality of values in a lookup table of the processor. Each of the plurality of values may be stored in a different respective entry of the lookup table—e.g. where each entry is accessible using a corresponding index value (or other such addressing information) for that entry. The stored plurality of values may, for example, be available in the lookup table for access by execution of another vector instruction—e.g. a dot-vmul instruction. In an embodiment, the stored plurality of values is available for access in the lookup table until an execution of another instruction of the vector definition instruction type. In an embodiment, execution of a dot-vdef instruction may result in a final storing of merely the calculated dot-product values in the lookup-table—e.g. where the reference vector itself may not be retained for later access.

One or more other vector instructions may be executed after the storing at 320, although certain embodiments are not limited in this regard. By way of illustration and not limitation, execution of a vector instruction which is subsequent to the instruction execution in method 300 may include looking up one or more values in the lookup table. In an embodiment, the instruction set implemented by the processor supports another vector instruction type for accessing to the stored plurality of values available in the lookup table. Such a vector instruction type may allow for merely implicit reference to the current reference vector and/or the plurality of values corresponding to the current reference vector. For example, the processor may further execute a second instruction of a vector multiplication instruction type supported by the instruction set. The second instruction may, for example, include data and/or address information to specify or otherwise indicate a second vector.

Execution of the second instruction may, for example, include determining, based on the stored plurality of values of the lookup table, a dot product of the current reference vector and an operand vector indicated by one or more parameters of the second instruction. Determining the dot product of the current reference vector and the operand vector may include identifying one or more terms which are to contribute (e.g. as an operand in an addition or multiplication operation) to a final dot-product value.

By way of illustration and not limitation, identifying such one or more terms may include identifying a first entry to access in the lookup table, where identifying the first entry is based on one or more—in one embodiment, each—of the elements of the operand vector. The value stored in the first entry may then be retrieved for use in determining a term to contribute to the final determination of the dot product value. In an embodiment, the retrieved value may serve as a term to be multiplied—e.g. based on a weight value associated with the term. Alternatively or in addition, the retrieved value—or a calculated multiple of the retrieved value—may be used as a term to be summed with one or more other terms for determining the dot product value.

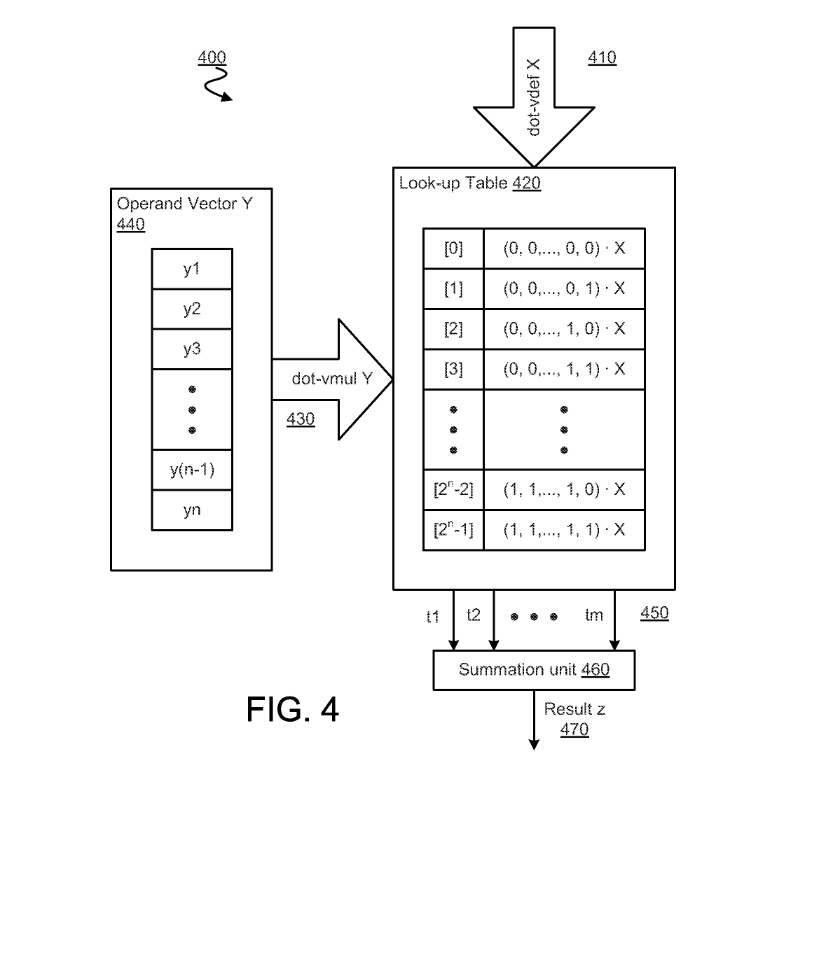

FIG. 4 is a functional representation of certain elements of a processor 400 for executing vector instructions according to an embodiment. Processor 400 may provide functionality to perform some or all operations of method 300, for example.

To illustrate certain features of different embodiments, operation of processor 400 is discussed herein with regard to a vector definition instruction to set some vector X as a reference vector, and a vector multiplication instruction to return a value equal to the dot-product of some operand vector Y and the current reference vector X. However, such discussion may be extended to apply to any of a variety of different vector instructions—e.g. for determining a dot-product of any of a variety of alternative pairs of vectors.

Processor 400 may include a look-up table 420 to store information which is similar to that stored in lookup table 235. Execution of a “dot-vdef X” instruction 410 may include calculating and storing in look-up table 420 a plurality of values each corresponding to a different respective Boolean vector. Each stored value may, for example, be equal to a dot-product of the vector X being set as the reference vector and the Boolean vector which corresponds to that value. By way of illustration and not limitation, X may be a vector including n elements where n is some positive integer—i.e. equal to or greater than 1.

In such an embodiment, execution of the “dot-vdef X” instruction 410 may store at least (2ⁿ-1) values, each value corresponding to a different respective Boolean vector having n elements. The values may be stored in respective entries of look-up table 420—e.g. where the entries are each indexed according to a respective index value which is based on the corresponding Boolean vector. By way of illustration and not limitation, lookup table 420 may include entries [1] through [2ⁿ-1], each storing a respective value which is equal to a dot-product of the reference vector and a corresponding Boolean vector. Lookup table 420 is also shown as including an entry [0] for corresponding to a Boolean vector with only elements which are value zero (0). However, processor 400 may forego storing such an entry [0] in certain embodiments, since a dot product including such a Boolean vector may be zero (0) regardless of vector X. In certain embodiments, dot-vdef and dot-vmul may be performed to define and multiply, respectively, a reference vector which has only a single element—e.g. where dot-vmul multiplies a given scalar value with a predefined reference scalar value.

In an embodiment, processor 400 may execute a “dot-vmul Y” instruction 430 to return a value equal to a dot-product of reference vector X and an operand vector Y 440. Execution of “dot-vmul Y” instruction 430 may include performing one or more table look-up operations to determine terms—represented by an illustrative set of terms t1, . . . , tm 450—which are to contribute to the determining of a final dot-product value. The terms t1, . . . , tm 450 may, for example, be provided to a summation unit 460 of processor 400—e.g. where summation unit 460 includes circuit logic to perform one or more addition operations based on terms t1, . . . , tm 450. Terms t1, . . . , tm 450 may be looked up and/or summated either sequentially or in parallel, according to different embodiments. The degree of parallelism of such lookups and/or summations may be constrained, for example, by a number of lookup table read ports and/or a number of ports of summation unit 460. However, multiple versions of look-up table 420 may be used to reduce a parallelism constraint imposed, for example, by some limited number of ports available to read from a single version of look-up table 420.

In an embodiment, summation unit 460 may variously multiply some or all of terms t1, . . . , tm 450 prior to such summation—e.g. the multiplying based on respective weight values associated with one or more of terms t1, . . . , tm 450. In an alternate embodiment, some or all of terms t1, . . . , tm 450 may be the result of such multiplication—e.g. where the multiplication is performed prior to terms t1, . . . , tm 450 being provided to summation unit 460. Based on terms t1, . . . , tm 450, summation unit 460 may calculate a result z 470 which is equal to a dot-product of operand vector Y and reference vector X. Result z 470 may be returned as a result of executing “dot-vmul Y” instruction 440.

The functionality of processor 400 is illustrated below with reference to a set of illustrative computations involving unsigned integers. However, such functionality may be extended to apply, according to different embodiments, to any of a variety of additional or alternative computations—e.g. for signed integer computations or signed fix-point number computations. In the illustrative example, processor 400 executes a vector definition instruction “dot-vdef A” which includes information to specify or otherwise indicate a vector A, where:

A=[3 2 1] (1)

In an embodiment, execution of the “dot-vdef A” instruction includes processor 400 calculating and storing in lookup table 420 a plurality of values each corresponding to a different respective Boolean vector. For each of the plurality of values, processor 400 may calculate a dot product of the first (reference) vector and the corresponding Boolean vector. Processor 400 may further store such a plurality of values in lookup table 420. Table 1 below illustrates elements of one example of such a lookup table.

TABLE 1
Lookup Entries Stored for Reference Vector A

| Entry | Stored Value |
|---|---|
| [0] | 0 (based on [0 0 0] · [3 2 1]) |
| [1] | 1 (based on [0 0 1] · [3 2 1]) |
| [2] | 2 (based on [0 1 0] · [3 2 1]) |
| [3] | 3 (based on [0 1 1] · [3 2 1]) |
| [4] | 3 (based on [1 0 0] · [3 2 1]) |
| [5] | 4 (based on [1 0 1] · [3 2 1]) |
| [6] | 5 (based on [1 1 0] · [3 2 1]) |
| [7] | 6 (based on [1 1 1] · [3 2 1]) |

The parenthetical information shown in Table 1 may not actually be stored in lookup table 420. The stored plurality of values of Table 1 may be available in lookup table 420 for access—e.g. by processor 400 executing another instruction subsequent to execution of the “dot-vdef A” instruction.

After vector A is set as the reference vector, processor 400 may execute one or more vector multiplication instructions—e.g. each to multiply a respective operand vector with the current reference vector A. By way of illustration and not limitation, processor 400 may receive multiple dot-vmul instructions which together implement at least in part a multiplication of a matrix B, where:

$$B = [ \begin{matrix}1 & 10 \\ 2 & 7 \\ 3 & 2\end{matrix} ] \qquad ( 2 )$$

The multiple dot-vmul instructions may each include a respective vector of matrix B—e.g. a respective one of vectors B1 and B2, where:

$$\begin{matrix}\begin{matrix}{B}_{1} = [ \begin{matrix}b 11 \\ b 12 \\ b 13\end{matrix} ] \\ = [ \begin{matrix}1 \\ 2 \\ 3\end{matrix} ] \\ = [ \begin{matrix}001 \\ 010 \\ 011\end{matrix} ]\end{matrix} & ( 3 ) \\ \begin{matrix}{B}_{2} = [ \begin{matrix}b 21 \\ b 22 \\ b 23\end{matrix} ] \\ = [ \begin{matrix}10 \\ 7 \\ 2\end{matrix} ] \\ = [ \begin{matrix}1010 \\ 0111 \\ 0010\end{matrix} ]\end{matrix} & ( 4 )\end{matrix}$$

For example, a “dot-vmul B1” instruction may return a value representing a result of the following calculation:

$$\begin{matrix}A \cdot B 1 = [ \begin{matrix}3 & 2 & 1\end{matrix} ] [ \begin{matrix}1 \\ 2 \\ 3\end{matrix} ] \\ = 3 + 4 + 3 \\ = 10\end{matrix} \qquad ( 5 )$$

whereas a “dot-vmul B2” instruction may return a value representing a result of the following calculation:

$$\begin{matrix}A \cdot B 2 = [ \begin{matrix}3 & 2 & 1\end{matrix} ] [ \begin{matrix}10 \\ 7 \\ 2\end{matrix} ] \\ = 30 + 14 + 2 \\ = 46\end{matrix} \qquad ( 6 )$$

In an embodiment, the respective values returned for the “dot-vmul B1” instruction and the “dot-vmul B2” instruction may be used to determine the following calculation.

C=A·B=[10 46] (7)

Execution of the “dot-vmul B1” instruction may include determining one or more entries of lookup table 420 from which respective values are to be retrieved.

In one embodiment, a process for determining the one or more entries may be based on the fact that a given operand vector may be equal to a sum of one or more component vectors which, in turn, are each equal to the sum of a respective binary vector multiplied by a respective 2^{x} value (where x is a weight value associated with the respective binary vector). For example, B1 may represented by component vectors as follows:

$$\begin{matrix}B 1 = [ \begin{matrix}1 \\ 2 \\ 3\end{matrix} ] \\ = 1 x [ \begin{matrix}1 \\ 0 \\ 1\end{matrix} ] + 2 x [ \begin{matrix}0 \\ 1 \\ 1\end{matrix} ] + 4 x [ \begin{matrix}0 \\ 0 \\ 0\end{matrix} ]\end{matrix} \qquad ( 8 )$$

An artifact of this ability to so represent vector B1 (or, similarly, other such operand vectors) is the corresponding ability to identify entries of a look-up table using techniques such as those illustrated in the following example. In an embodiment, determining entries may be based on a binary representation of the elements of B1—e.g. as shown in Table 2.

TABLE 2
Binary Representation of Elements in Vector B1

| | Binary Bit | | |
|---|---|---|---|
| Element | x2 | x1 | x0 |
| b11 | 0 | 0 | 1 |
| b12 | 0 | 1 | 0 |
| b13 | 0 | 1 | 1 |

The bits comprising the binary representation of the elements in B1 may be variously grouped and ordered to determine index information for accessing lookup table 420. For example, each element in B1 may contribute to a bit of a particular significance (or “weight”)—e.g. where bits x0, x1, x2 are bits of increasing significance—to a respective group to determine an index value for looking up a value corresponding to that significance/weight. The grouped bits of a particular bit significance may be arranged according to the order of the elements in vector B1. An example of index information resulting from such groping and ordering is shown in Table 3 below.

TABLE 3
Index Information for Lookups Based on Vector B1

| | Element | | | |
|---|---|---|---|---|
| Binary Bit | b11 | b12 | b13 | Index |
| x0 | 1 | 0 | 1 | 5 |
| x1 | 0 | 1 | 1 | 3 |
| x2 | 0 | 0 | 0 | 0 |

Based on the index information represented in Table 3, processor 400 may access some or all of entries [5], [3] and [0] and retrieve the respective values stored therein. In an embodiment, processor 400 may forego performing a lookup based on index information for entry [0]—e.g. where processor 400 instead automatically associates the value zero (0) with such index information.

The values retrieved from lookup table 420 may be used to generate terms which contribute to a final dot-product result for A·B1. In an embodiment, each of the retrieved values is to be multiplied based on the bit significance/weight associated with the index information used to retrieve that value. Multiplying a retrieved value may, for example, be implemented by a register shift of the retrieved value.

The resulting terms may then be added to generate a value equal to a dot-product of the operand vector B1 and the current reference vector A. An example of multiplication (e.g. by shifting) of retrieved values, and addition of the resulting terms, is shown in Table 4 below.

TABLE 4
Processing of Lookup Table Values to Determine A · B1

| Entry | Entry | Bit | | | |
|---|---|---|---|---|---|
| Index | Value | Position | Shift | Term | Result |
| 5 | 4 | 0 | 0 (x1) | 4 | 10 |
| 3 | 3 | 1 | 1 (x2) | 6 | |
| 0 | 0 | 2 | 2 (x4) | 0 | |

Execution of the “dot-vmul B2” instruction may include operations similar to those performed to execute the “dot-vmul B1” instruction. For example, entries of look-up table 420 may be determined based on a binary representation of the elements in B2—e.g. as shown in Table 5 below.

TABLE 5
Binary Representation of Elements in Vector B2

Binary Bit

| Element | x3 | x2 | x1 | x0 |
|---|---|---|---|---|
| b21 | 1 | 0 | 1 | 0 |
| b22 | 0 | 1 | 1 | 1 |
| b23 | 0 | 0 | 1 | 0 |

The bits comprising the binary representation of the elements in B2 may be various grouped with one another and ordered to determine index information for accessing lookup table 420. An example of the determined index information for vector B2 is shown in Table 6 below.

TABLE 6
Index Information for Lookups Based on Vector B2

| | Element | | | |
|---|---|---|---|---|
| Binary Bits | b21 | b22 | b23 | Index |
| x0 | 0 | 1 | 0 | 2 |
| x1 | 1 | 1 | 1 | 7 |
| x2 | 0 | 1 | 0 | 2 |
| x3 | 1 | 0 | 0 | 4 |

Based on the index information represented in Table 6, processor 400 may access entries [2], [7] and [4] and retrieve the respective values stored therein. In an embodiment, processor 400 accesses entry [2] once for the purpose of calculating two different terms.

The values retrieved from lookup table 420 may be used to generate terms which contribute to a final dot-product result for A·B2. In an embodiment, each of the retrieved values is to be multiplied based on the bit significance/weight associated with the index information used to retrieve that value. The resulting terms may then be added to generate a value equal to a dot-product of the operand vector B2 and the current reference vector A. An example of shift multiplication of retrieved values, and addition of the resulting terms, is shown in Table 7 below.

TABLE 7
Processing of Lookup Table Values to Determine A · B2

| Entry | Entry | Bit | | | |
|---|---|---|---|---|---|
| Index | Value | Position | Shift | Term | Result |
| 2 | 2 | 0 | 0 (x1) | 2 | 46 |
| 7 | 6 | 1 | 1 (x2) | 12 | |
| 2 | 2 | 2 | 2 (x4) | 8 | |
| 4 | 3 | 3 | 3 (x8) | 24 | |

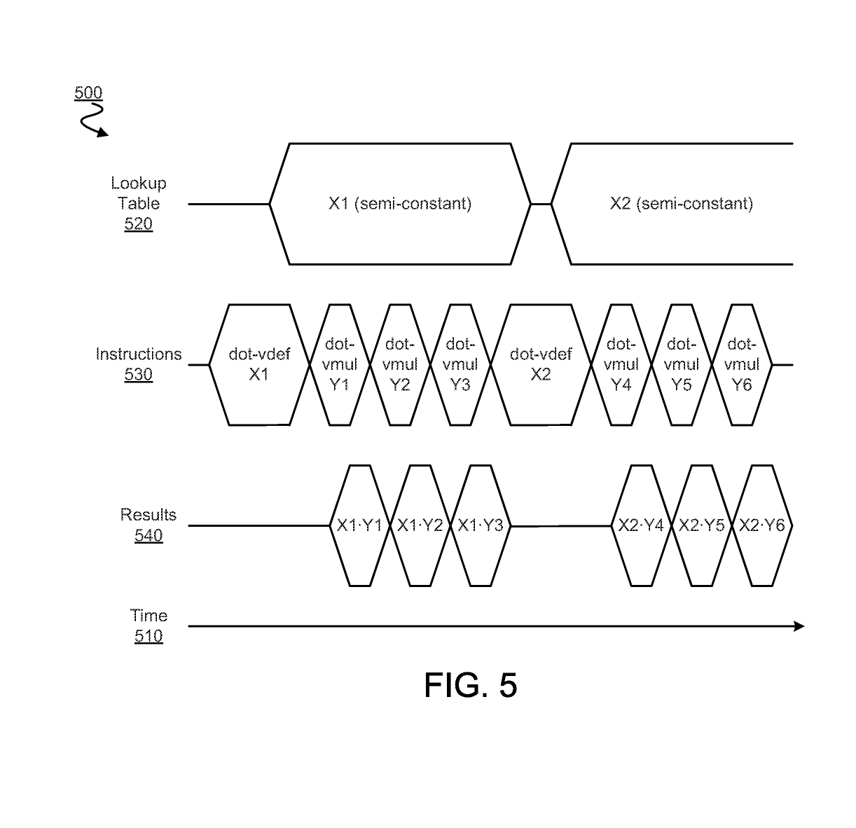

FIG. 5 illustrates a timing diagram 500 showing operations to execute vector instructions according to an embodiment. Timing diagram 500 may, for example, represent signals exchanged during execution of various vector instructions by processor 400.

Timing diagram 500 shows an illustrative set of instructions 530 which may be executed over time 510 by the processor. Moreover, timing diagram 500 shows how different information in lookup table 520 may be stored at different times—e.g. the stored information to support at least in part implementation of various reference vectors.

By way of illustration and not limitation, instructions 530 may include a “dot-vdef X1” instruction to set a vector X1 as the reference vector. Execution of the “dot-vdef X1” instruction may result in lookup table 520 storing a plurality of dot-product values to be made available for one or more subsequent instruction executions. Information stored in lookup table 520 for reference vector X1 may be considered “semi-constant” at least insofar as such information remains available for access in lookup table 520 until a particular event occurs. For example, information for implementing X1 as the reference vector may remain available in lookup table 520 until another dot-vdef instruction explicitly sets some other vector as the reference vector.

The information in lookup table 520 for current reference vector X1 may be accessed by executing one or more vector instructions. By way of illustration and not limitation, multiple vector multiplication instructions, represented by an illustrative “dot-vmul Y1”, “dot-vmul Y2” and “dot-vmul Y3,” may each be executed—e.g. to determine dot-products for vectors, Y1, Y2 and Y3, respectively. For example, execution of “dot-vmul Y1”, “dot-vmul Y2” and “dot-vmul Y3” may return dot-product values for X1·Y1, X1·Y2 and X1·Y3, respectively.

Additionally or alternatively, instructions 530 may include a “dot-vdef X2” instruction to set a vector X2 as the reference vector. Execution of the “dot-vdef X2” instruction may result in lookup table 520 replacing the plurality of dot-product values for the previous reference vector X1 with another plurality of dot-product values for the new reference vector X2. As with previous reference vector X1, information stored in lookup table 520 for current reference vector X2 may be considered semi-constant at least insofar as such information remains available for access in lookup table 520 until a particular event occurs·e.g. until another dot-vdef instruction explicitly sets some third vector as the reference vector.

The information in lookup table 520 for current reference vector X2 may be accessed by executing one or more vector instructions. By way of illustration and not limitation, multiple vector multiplication instructions, represented by an illustrative “dot-vmul Y4”, “dot-vmul Y5” and “dot-vmul Y6,” may each be executed to determine dot-products for vectors, Y4, Y5 and Y6, respectively. For example, execution of “dot-vmul Y4”, “dot-vmul Y5” and “dot-vmul Y6” may return dot-products for X2·Y4, X2·Y5 and X2·Y6, respectively.

Techniques and architectures for performing a vector calculation are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A method at a processor, the method including:
executing a first instruction of a vector definition instruction type, the first instruction including an indication of a first vector, wherein an instruction set of the processor includes the vector definition instruction type, the executing the first instruction including:
calculating a set of one or more values each corresponding to a different respective Boolean vector, including for each of the set of one or more values, calculating a dot product of the first vector and the corresponding Boolean vector; and
storing the set of one or more values in a lookup table of the processor, wherein the stored set of one or more values is available in the lookup table for access by an execution of an instruction subsequent to execution of the first instruction.

2. The method of claim 1, wherein the vector definition instruction type supports implicit reference by the first instruction to the corresponding Boolean vectors for the set of one or more values.

3. The method of claim 1, wherein the instruction set supports an instruction type for access by implicit reference to the stored set of one or more values available in the lookup table.

4. The method of claim 1, wherein the stored set of one or more values is available for access in the lookup table until an execution of another instruction of the vector definition instruction type.

5. The method of claim 1, further comprising:
executing a second instruction of a vector multiplication instruction type, the second instruction including an indication of a second vector, wherein the instruction set further includes the vector multiplication instruction type, the executing the second instruction including:
determining, based on the stored set of one or more values of the lookup table, a dot product of the first vector and the second vector.

6. The method of claim 5, wherein the second vector includes a plurality of elements, wherein each of the set of one or more values is stored in a different respective entry of the lookup table, wherein determining the dot product of the first vector and the second vector includes:
identifying a first entry to access in the lookup table, the identifying the first entry based on each of the plurality of elements of the second vector; and
determining a first term based on a first value stored in the first entry.

7. The method of claim 6, wherein determining the first term include multiplying the first value according to a weight value associated with the first term.

8. A system comprising:
a bus to exchange a first instruction of a vector definition instruction type, the first instruction including an indication of a first vector;
a processor coupled to the bus, the processor including:
a memory to store a look-up table;
a decoder to detect the first instruction, wherein an instruction set of the processor includes the vector definition instruction type; and
an execution unit to execute the first instruction, including:
the execution unit to calculate a set of one or more values each corresponding to a different respective Boolean vector, including for each of the set of one or more values, the execution unit to calculate a dot product of the first vector and the corresponding Boolean vector; and
the execution unit to store the set of one or more values in the lookup table, wherein the stored set of one or more values is available in the lookup table for access by an execution of an instruction subsequent to execution of the first instruction; and
a network interface coupled to the processor, the network interface to connect the system to a network.

9. The system of claim 8, wherein the vector definition instruction type supports implicit reference by the first instruction to the corresponding Boolean vectors for the set of one or more values.

10. The system of claim 8, wherein the instruction set supports an instruction type for access by implicit reference to the stored set of one or more values available in the lookup table.

11. The system of claim 8, wherein the stored set of one or more values is available for access in the lookup table until an execution of another instruction of the vector definition instruction type.

12. The system of claim 8, the execution unit further to execute a second instruction of a vector multiplication instruction type, the second instruction including an indication of a second vector, wherein the instruction set further includes the vector multiplication instruction type, wherein the execution unit to execute the second instruction includes the execution unit to determine, based on the stored set of one or more values of the lookup table, a dot product of the first vector and the second vector.

13. The system of claim 12, wherein the second vector includes a plurality of elements, wherein each of the set of one or more values is stored in a different respective entry of the lookup table, wherein the execution unit to determine the dot product of the first vector and the second vector includes:
the execution unit to identify a first entry to access in the lookup table, the identifying the first entry based on each of the plurality of elements of the second vector; and
the execution unit to determine a first term based on a first value stored in the first entry.

14. The system of claim 13, wherein the execution unit to determine the first term includes the execution unit to multiply the first value according to a weight value associated with the first term.

15. A processor comprising:
a memory to store a look-up table;
a decoder to detect a first instruction of a vector definition instruction type, the first instruction including an indication of a first vector, wherein an instruction set of the processor includes the vector definition instruction type; and
an execution unit to execute the first instruction, including:
the execution unit to calculate a set of one or more values each corresponding to a different respective Boolean vector, including for each of the set of one or more values, the execution unit to calculate a dot product of the first vector and the corresponding Boolean vector; and
the execution unit to store the set of one or more values in the lookup table, wherein the stored set of one or more values is available in the lookup table for access by an execution of an instruction subsequent to execution of the first instruction.

16. The processor of claim 15, wherein the vector definition instruction type supports implicit reference by the first instruction to the corresponding Boolean vectors for the set of one or more values.

17. The processor of claim 15, wherein the instruction set supports an instruction type for access by implicit reference to the stored set of one or more values available in the lookup table.

18. The processor of claim 15, wherein the stored set of one or more values is available for access in the lookup table until an execution of another instruction of the vector definition instruction type.

19. The processor of claim 15, the execution unit further to execute a second instruction of a vector multiplication instruction type, the second instruction including an indication of a second vector, wherein the instruction set further includes the vector multiplication instruction type, wherein the execution unit to execute the second instruction includes:
the execution unit to determine, based on the stored set of one or more values of the lookup table, a dot product of the first vector and the second vector.

20. The processor of claim 19, wherein the second vector includes a plurality of elements, wherein each of the set of one or more values is stored in a different respective entry of the lookup table, wherein the execution unit to determine the dot product of the first vector and the second vector includes:
the execution unit to identify a first entry to access in the lookup table, the identifying the first entry based on each of the plurality of elements of the second vector; and
the execution unit to determine a first term based on a first value stored in the first entry.

21. The processor of claim 20, wherein the execution unit to determine the first term includes the execution unit to multiply the first value according to a weight value associated with the first term.
